(19) United States
(12) Patent Application Publication
(10) Pub. No.: US 2018/0225284 A1
(43) Pub. Date: Aug. 9, 2018

(54) INFORMATION PROCESSING APPARATUS, INFORMATION PROCESSING METHOD, AND PROGRAM

(71) Applicants: Denso IT Laboratory, Inc., Tokyo (JP); Ochanomizu University, Tokyo (JP)

(72) Inventors: Hiroshi Tsukahara, Tokyo (JP); Ichiro Kobayashi, Tokyo (JP); Akari Inago, Tokyo (JP)

(21) Appl. No.: 15/887,122

(22) Filed: Feb. 2, 2018

(30) Foreign Application Priority Data
Feb. 3, 2017 (JP) 2017-018850

(51) Int. Cl. G06F 17/28; G06F 17/27; G06F 17/30; G06N 5/02; G06N 5/04

(52) U.S. Cl. CPC G06F 17/28; G06F 17/2785; G06F 17/2755; G06N 5/04; G06F 17/30625; G06N 5/02; G06F 17/2735

(57) ABSTRACT

An information processing apparatus 1 comprises: a dictionary DB 15 storing categories of constituents and storing information representing a semantic interpretation, the dictionary DB 15 containing as the categories the category of object and the category of spatial location; a morphological parser 22 for performing morphological parsing of an inputted sentence; a tree structure generator 23 for, with reference to information stored in the dictionary DB 15, providing categories and lambda expressions of constituents each consisting of a morpheme or a bundle of neighboring morphemes obtained by the morphological parser 22, generating a tree structure in which the categories are hierarchically put together by combining neighboring categories in accordance with a predetermined function application rule, and generating a lambda expression representing the sentence; and a hierarchical structure generator 24 for generating a hierarchical structure in which atomic categories of the tree structure are set as nodes.

### CROSS REFERENCE TO RELATED APPLICATION

This nonprovisional application is based on Japanese Patent Application No. 2017-18850 filed with the Japan Patent Office on Feb. 3, 2017, the entire contents of which are hereby incorporated by reference.

### FIELD

This invention relates to an information processing apparatus for natural language processing and, in particular, to an information processing apparatus for analyzing information contained in a control instruction about an object present in a space.

### BACKGROUND AND SUMMARY

Conventionally, there has been known a manner in which a control instruction about an object present in a space is given to a robot by voice (Japanese Patent Laid-Open Application No. 2011-170789). This technique, however, would not extract spatial meaning of an object and therefore could not handle relations between relative positions of objects or between control information and an object.

In contrast to this, there is a prior study on a technique that represents spatial semantic information in a hierarchical structure and extracts from a natural language sentence a spatial semantic structure therein with probabilistic means (T. Koller et al., Towards Understanding Natural Language Directions, Proceedings of the 5th ACM/IEEE International Conference on Human-robot Interaction).

The non-patent document mentioned above supposes the environment to be static as in a building. The technique described in the non-patent document requires that control information be taught to a robot beforehand in a static environment, and therefore cannot apply to a dynamically changing state like a driving environment.

For example, imagine an environment where a driver verbally gives driving instructions in a self-driving car or the like. The technique described in the non-patent document cannot apply to the environment since the environment changes dynamically and continuously and, even if it can apply, there still remains a problem that it can apply only in an extremely limited, i.e. static and known, environment.

A purpose of the invention is to provide a technique for converting information contained in a real-world control instruction expressed in natural language to a data structure suited for establishing correspondences with the real world (grounding).

### Means for Solving the Problems

An information processing apparatus of the invention is for processing a sentence inputted from an input unit, and comprises: a dictionary database storing categories of constituents each consisting of a morpheme or a bundle of morphemes and storing information representing a semantic interpretation of each constituent, the dictionary database containing as the categories the category of object and the category of spatial location; a morphological parser for performing morphological parsing of an inputted sentence; a tree structure generator for, with reference to information stored in the dictionary database, providing categories and semantic interpretations of constituents each consisting of a morpheme or a bundle of neighboring morphemes obtained by the morphological parser, generating a tree structure in which the categories are hierarchically put together by combining neighboring categories in accordance with a predetermined function application rule, and generating the meaning of the sentence; and a hierarchical structure generator for generating a hierarchical structure in which atomic categories of the tree structure are set as nodes. The hierarchical structure generator may convert the tree structure to generate the hierarchical structure. This configuration allows a hierarchical structure to be used to identify (ground) an object present in an external space. A set of lambda or other logical expressions or a set of vectors can be used as information representing semantic interpretations of constituents. If a set of logical expressions is used, a logical expression for each constituent can be composed through application of a function to generate a compound logical expression. If a set of vectors is used, a vector of a whole sentence can be composed through application of a function to generate a new vector from two vectors to branches of a tree structure (recursive neural network).

The information processing apparatus of the invention may comprise: a detector for acquiring data on a spatial position relation between objects present in an external space; a grounding graph generator for generating a grounding graph that has a plurality of submodels connected together according to the hierarchical structure and provides a certainty factor as a function of certainty factors of the submodels, each submodel having a first variable group related to the constituents of the sentence, a second variable group related to spatial position relations between objects, and a third variable group related to correspondence relations in grounding; and a matching unit for applying data on spatial position relations between objects detected by the detector to the second variable group of the grounding graph and identifying the objects indicated in the sentence. This configuration allows for identifying an object present in an external space indicated in an inputted sentence.

In the information processing apparatus of the invention, the tree structure generator may determine whether the inputted sentence is consistent with background knowledge or not based on the meaning of the sentence and the meaning supported by background knowledge. This allows for checking representational correctness based on background knowledge and rephrasing an inputted sentence into an appropriate expression from which a hierarchical structure can be generated. For example, if logical expressions are used to represent semantic interpretations of constituents, whether the sentence is consistent or not can be determined based on whether the value of their compound logical expression is true or false. If vectors are used to represent semantic interpretations of constituents, whether the sentence is consistent or not can be determined based on threshold processing of the angle between vectors (consistent if it is smaller than a threshold or inconsistent otherwise), inclusion relation between predetermined vicinity (zones) of vectors (consistent if one is included in another or inconsistent otherwise), or the like.

In the information processing apparatus of the invention, the dictionary database may contain as the category a category related to the location of a viewpoint. For example, there may be such a sentence whose viewpoint is not its utterer as “on the left as seen from . . . ” The configuration of the invention allows for handling even these expressions with a change in viewpoint.

In the information processing apparatus of the invention, the dictionary database may contain as the category a category related to the state of an object or a space. This configuration allows for appropriately distinguishing and recognizing the same objects or spaces whose states are different from one another.

In the information processing apparatus of the invention, the dictionary database may contain as the category a category related to a path. This configuration allows for handling even an expression for a path connecting multiple points.

The information processing apparatus of the invention may comprise a representation correction processor for rephrasing a sentence inputted from the input unit as required. This configuration allows for modifying a sentence into a representation from which a tree structure and a hierarchical structure are easy to generate.

The information processing apparatus of the invention may comprise a representation processor for converting a sentence inputted from the input unit to a plurality of simple sentences if the sentence is a complex sentence. This configuration allows for modifying a sentence into a representation from which a tree structure and a hierarchical structure are easy to generate.

In the information processing apparatus of the invention, the tree structure generator may generate the tree structure by inferring wording omitted from the sentence based on a knowledge database storing background knowledge. Part of a sentence is often omitted in everyday conversation. Japanese in particular permits omission of the subject and object, which are called zero pronouns. The invention allows even a sentence with some omissions to be handled by inferring omitted wording based on the knowledge database.

In the information processing apparatus of the invention, the tree structure generator may determine that some wording is omitted from the sentence and infer the omitted wording if neighboring categories do not conform with a predetermined function application rule. This allows for appropriately recognizing that some wording is omitted and inferring the omitted wording.

The information processing apparatus of the invention may determine that some wording is omitted from the sentence and may infer the omitted wording if an object corresponding to the second variable group of the grounding graph is not identified by the matching unit. This allows for appropriately recognizing that some wording is omitted and inferring the omitted wording.

In the information processing apparatus of the invention, the tree structure generator may generate a tree structure by inferring the nature of an unknown word contained in an inputted sentence based on data on constituents stored in the dictionary database or based on the context of the inputted sentence. This allows for appropriately handling a sentence containing a new designation that is not included in the categories of the dictionary database.

In the information processing apparatus of the invention, the tree structure generator may determine a plurality of potential syntax trees consisting of constituents each consisting of a morpheme or a bundle of neighboring morphemes, may rerank the plurality of potential syntax trees with a (feature-based) predictive analysis using, as the features of a syntax tree, (i) the number of appearances of grammar rule patterns, (ii) the number of N-grams of segments, (iii) the number of segment-category pairs, and (iv) the number of subtrees, and may generate a tree structure with a maximum probability of being correct. This configuration allows for generating a highly accurate tree structure.

An information processing method of the invention is for parsing a sentence inputted from a user by means of an information processing apparatus, and comprises the steps of: the information processing apparatus receiving an input of a sentence from a user; the information processing apparatus performing morphological parsing of an inputted sentence; the information processing apparatus, with reference to information stored in a dictionary database storing categories of constituents each consisting of a morpheme or a bundle of morphemes and storing information representing a semantic interpretation of each constituent, the dictionary database containing as the categories the category of object and the category of spatial location, providing categories and semantic interpretations of constituents each consisting of a morpheme or a bundle of neighboring morphemes obtained by the morphological parsing, generating a tree structure in which the categories are hierarchically put together by combining neighboring categories in accordance with a predetermined function application rule, and generating the meaning of the sentence; and the information processing apparatus generating a hierarchical structure in which atomic categories of the tree structure are set as nodes. The hierarchical structure may be converted from the tree structure.

A program of the invention is for parsing a sentence inputted from a user, and causes a computer to execute the steps of: receiving an input of a sentence from a user; performing morphological parsing of an inputted sentence; with reference to information stored in a dictionary database storing categories of constituents each consisting of a morpheme or a bundle of morphemes and storing information representing a semantic interpretation of each constituent, the dictionary database containing as the categories the category of object and the category of spatial location, providing categories and semantic interpretations of constituents each consisting of a morpheme or a bundle of neighboring morphemes obtained by the morphological parsing, generating a tree structure in which the categories are hierarchically put together by combining neighboring categories in accordance with a predetermined function application rule, and generating the meaning of the sentence; and generating a hierarchical structure in which atomic categories of the tree structure are set as nodes. The hierarchical structure may be converted from the tree structure.

The invention allows for identifying (grounding) an object present in an external space by generating a logical expression that represents a hierarchical structure of an inputted sentence.

The foregoing and other objects, features, aspects and advantages of the exemplary embodiments will become more apparent from the following detailed description of the exemplary embodiments when taken in conjunction with the accompanying drawings.

### BRIEF DESCRIPTION OF THE DRAWINGS

FIG. 1 shows a configuration of an information processing apparatus of an embodiment;

FIG. 2 shows an example of data stored in a dictionary DB;

FIG. 3A is an example of data stored in a learning corpus;

FIG. 3B is an example of data stored in the learning corpus;

FIG. 3C is an example of data stored in the learning corpus;

FIG. 4 shows an example of a tree structure;

FIG. 5 shows an example of lambda expressions;

FIG. 6A shows an example of a hierarchical data structure representing spatial meaning;

FIG. 6B shows an example of a grounding graph;

FIG. 7 shows an operation of the information processing apparatus acquiring external objects and their relation data;

FIG. 8 shows an operation of analyzing information contained in a control sentence when the sentence is inputted from a driver;

FIG. 9 shows an example of grounding a real object using the information processing apparatus of the embodiment;

FIG. 10 shows an example of a tree structure;

FIG. 11 shows an example of lambda expressions;

FIG. 12A shows an example of a hierarchical data structure representing spatial meaning;

FIG. 12B shows an example of a grounding graph;

FIG. 13A shows an example of the division of a complex sentence into simple sentences;

FIG. 13B shows an example of tree structures;

FIG. 14 shows grammar rule patterns in an illustrative syntax tree;

FIG. 15 shows the number of N-grams in the illustrative syntax tree;

FIG. 16 shows the number of segment-category pairs in the illustrative syntax tree; and

FIG. 17 shows the structures of subtrees with a depth of 2 to 5 in the illustrative syntax tree.

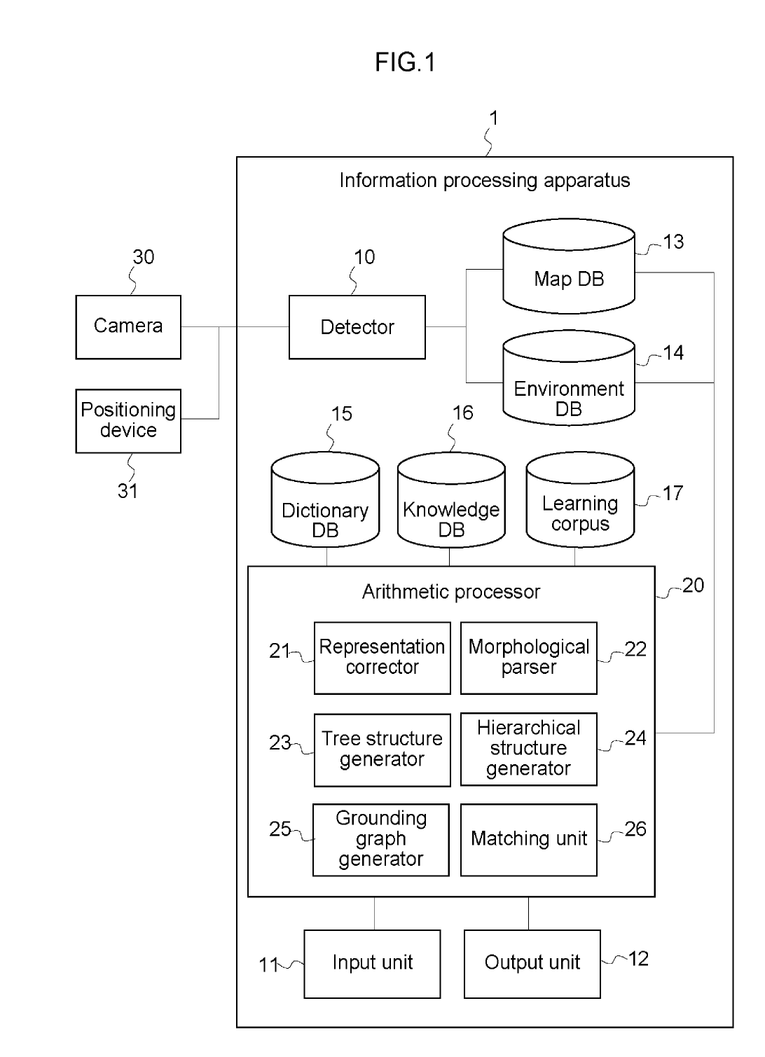

### DETAILED DESCRIPTION OF NON-LIMITING EXAMPLE EMBODIMENTS

Now, an information processing apparatus of an embodiment of the invention will be described with reference to the drawings. In the embodiment described below, the information processing apparatus 1 parses a control sentence inputted from a user and establishes correspondences (grounds) between objects present in an external environment and information instructed in a control sentence. The information processing apparatus 1 is used mounted on a vehicle and analyzes the meaning of a control sentence inputted from a user to give driving instructions to a self-driving controller of the vehicle, for example. The use of the information processing apparatus 1 is not limited to parsing control sentences for self-driving purposes, but it is used for natural-language based Interfaces of every kind.

The hardware of the information processing apparatus 1 comprises a computer (e.g. ECU) equipped with a CPU, RAM, ROM, a hard disk, a monitor, a speaker, a microphone, and the like. The computer is connected with a camera 30 and a positioning device 31 as devices to acquire external environment data. A GPS, for example, can be used as the positioning device 31. A device can also be used that determines positions by combining GPS positioning information and the travel speed, the rotational speed of tires, or other information. Items described here are for illustrative purposes only, and the concrete configuration of the positioning device 31 is not limited to the specific examples mentioned above.

The information processing apparatus 1 has a detector 10 for receiving data from the camera 30 and positioning device 31 to detect an external object or the like. The detector 10 identifies the current location and buildings around there based on positioning data inputted from the positioning device 31 and on a map database (hereinafter referred to as the “map DB”) 13. The detector 10, along with detecting surrounding objects (hereinafter also referred to as “real objects”) from images taken by the camera 30, detects data on a position relation between the real objects (hereinafter referred to as “object relation data”) and stores it in an environment database (hereinafter referred to as the “environment DB”) 14. The real objects mentioned above are, for example, a vehicle and a parking space. The object relation data is a relation between real objects, e.g. the occupancy of a parking space.

The information processing apparatus 1 has an input unit 11 for receiving an input of a control sentence from a user, an arithmetic processor 20 for parsing the inputted control sentence to ground it to real objects, and an output unit 12 for outputting information contained in the control sentence grounded to real objects. The output unit 12 is connected to a self-driving controller not shown in the figures and causes it to perform driving control of the vehicle according to the control information. A concrete example of the input unit 11 is a microphone, and a concrete example of the output unit 12 is an interface terminal connected to the self-driving controller. A speaker or display can be used as the output unit 12 when a grounding result is outputted to a user. The specific examples mentioned above are for illustrative purposes only, and the input unit 11 and the output unit 12 are not limited to the specific examples mentioned above.

The arithmetic processor 20 has functions of a representation corrector 21, morphological parser 22, tree structure generator 23, hierarchical structure generator 24, grounding graph generator 25, and matching unit 26. These functions to be executed through arithmetic processing are carried out by the computer comprising the information processing apparatus 1 executing predetermined programs.

The representation corrector 21 has a function to correct the representation of an inputted control sentence. The representation corrector 21 has a function to perform pattern matching or the like on an inputted control sentence and, if the sentence matches a predetermined pattern, rephrase the control sentence or make up for an omitted word. The morphological parser 22 has a function to perform morphological parsing of a control sentence corrected by the representation corrector 21. For example, if an inputted control sentence is “Where to stop is the vacant space on the most right,” the representation corrector 21 detects that the sentence matches a pattern “Where to stop is . . . ,” and rephrases the sentence to a control sentence “Stop at the vacant space on the most right.” This allows an event intended in a control sentence to be clear and allows the subsequent process to be performed appropriately.

The tree structure generator 23 has a function to, with reference to information stored in a dictionary database (hereinafter referred to as the “dictionary DB”) 15, provide categories of constituents each consisting of a morpheme or a bundle of neighboring morphemes obtained by the morphological parser 22, and generate a tree structure in which the categories are hierarchically put together by combining neighboring categories in accordance with a predetermined function application rule.

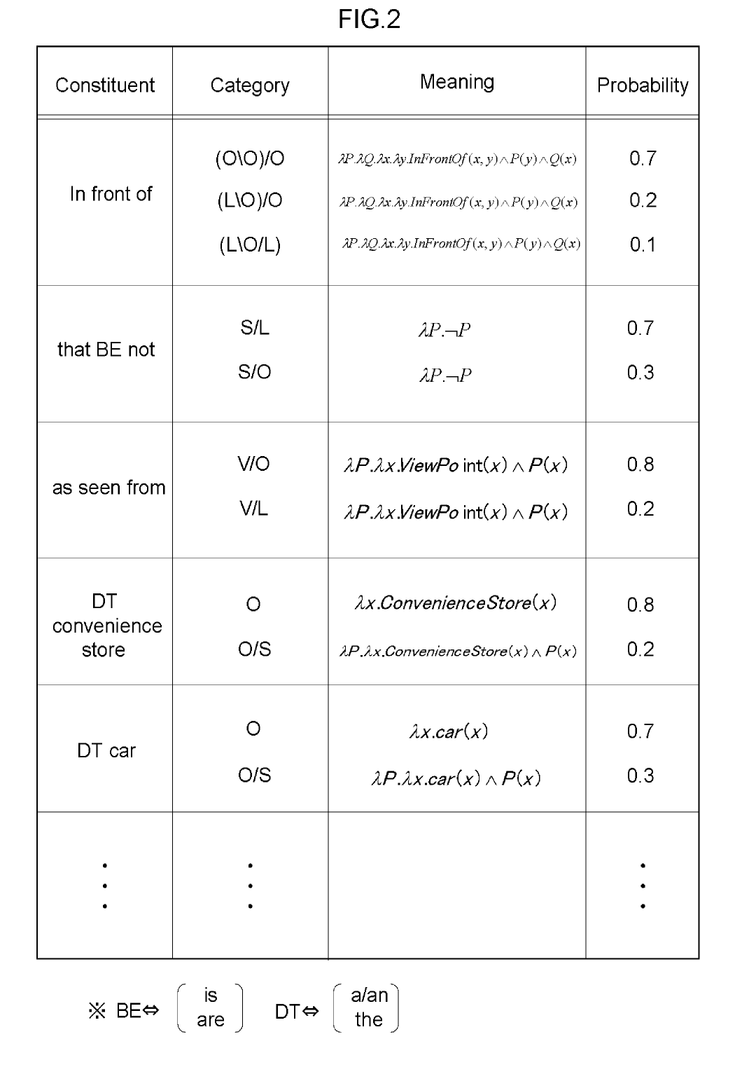

FIG. 2 shows an example of data stored in the dictionary DB 15. The dictionary DB 15 stores constituents each consisting of a morpheme or a combination of morphemes, categories given to the constituents, the meanings of the constituents, and probability data corresponding to the categories. The categories in the information processing apparatus 1 of the embodiment include O (object), L (location), S (state), V (viewpoint), E (event), and P (path).

O (object) indicates that a constituent is an object, and “DT convenience store” and “DT car” in the example in FIG. 2 correspond to this category. L (location) indicates a spatial location, and a constituent “near” (not shown in the figure), for example, corresponds to this category. S (state) corresponds to a constituent indicating a state, and “that BE not” in the example in FIG. 2 corresponds to this category. V (viewpoint) indicates a viewpoint, and “as seen from” in the example in FIG. 2 corresponds to this category. E (event) corresponds to a constituent indicating an operation, and a constituent “stop,” for example, corresponds to this category. P (path) corresponds to a representation indicating a path connecting multiple points, and “on the far side of” and “toward the exit,” for example, correspond to this category.

The “Category” item in the dictionary DB 15 has information indicating a category of a relevant constituent and, additionally, information on categories of constituents before and after the relevant constituent when they modify the relevant constituent from the front and back. “¥” and “/” included in the categories are operators. “¥” indicates that a constituent modifies a relevant constituent from the left (i.e. front), and “/” indicates that a constituent modifies a relevant constituent from the right (i.e. back). For example, “V/O” indicates that the constituent is of V (view) and that O (object) modifies it from the right. Consequently, “as seen from” is a constituent that creates a combination “as seen from (object).” While the present application uses “¥,” the symbol opposite of “/” may be used.

The meaning of a constituent is represented by a set of lambda expressions. Because of this representation of the meaning of a constituent using lambda expressions, neighboring constituents can be composed with one another through application of a function application rule for lambda expressions. While the embodiment uses lambda expressions, which belong to logical expressions, to represent the meanings of constituents, information representing the meaning of constituents is not limited to lambda expressions, and vectors, for example, can also be used.

Probability data stored in the dictionary DB 15 is the probability that each category given to each constituent is accurate. This probability is obtained by, for example, parsing multiple sentences stored in a learning corpus 17.

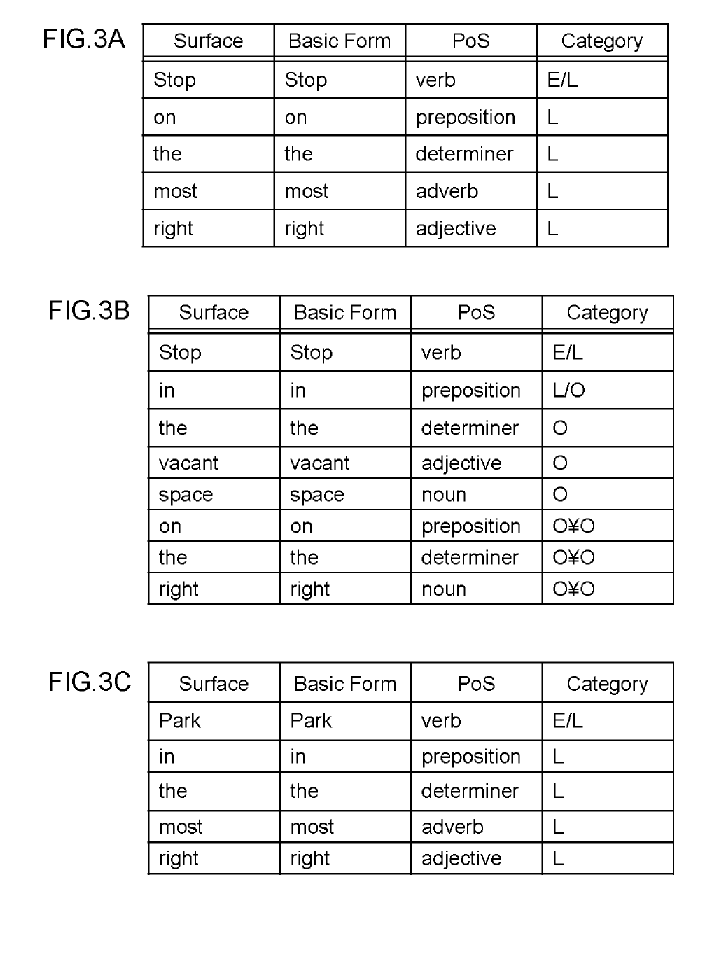

FIGS. 3A to 3C are examples of data stored in the learning corpus 17. FIGS. 3A to 3C show examples in which sentences different from one another are divided into morphemes. The learning corpus 17 stores morpheme data that frame sentences and the corresponding basic form, part of speech, and category data. The learning corpus 17 stores a huge number of sentences like those shown in FIGS. 3A to 3C, and the probability that a category fits a constituent can be determined by analyzing parts of speech and categories seen in sentences contained in the learning corpus 17. If categories of a series of morphemes are the same, the series of morphemes is handled as one morpheme. For example, since “on,” “the, “most,” and “right” all correspond to the category L (location), “on the most right” is handled as one constituent, to which the category L (location) is given.

The tree structure generator 23 performs Shift Reduce Parsing on morphemes obtained by the morphological parser 22, and determines constituents and their categories. Specifically, morphemes are held in the stack from the top of a control sentence (Shift), the morphemes held in the stack are retrieved as one constituent if there is the corresponding constituent in the dictionary DB 15 (Reduce), and this process is repeated.

In this regard, which morphemes are to be retrieved as one constituent is determined by causing a discriminator to learn using data in the learning corpus 17. For example, the probability value for each control is calculated with logistic regression, and one with a high probability value is selected. While parsing is done, the process (beam search) is performed with top N parsing results with a high probability value being held. When parsing is complete, one with the highest probability value among the top N parsing candidates may be outputted as the parsing result or, as an addition, the top N candidates may be reranked based on feature amounts about the number of repetitions of reducing and a tree structure of the parsing result as well as on the probability value and one with the highest rank may be outputted as the parsing result. The number of appearances of all subtrees included in a tree structure or the like is used as a feature amount of a tree structure. Logistic regression or other discriminator is used for the reranking. This discriminator learns using the learning data, too.

Reranking will be described here. Reranking is performed based on the probability related to the accuracy of a syntax tree obtained as a parsing result. The probability related to the accuracy is determined by a logistic regression analysis with a syntax tree of correct solution data being the positive class and a syntax tree of an incorrect solution among solutions outputted from the parser being the negative class. Used as the features of a syntax tree are: (i) the number of appearances of grammar rule patterns; (ii) the number of N-grams of segments; (iii) the number of segment-category pairs; and (iv) the number of subtrees. These features will be described next with reference to drawings.

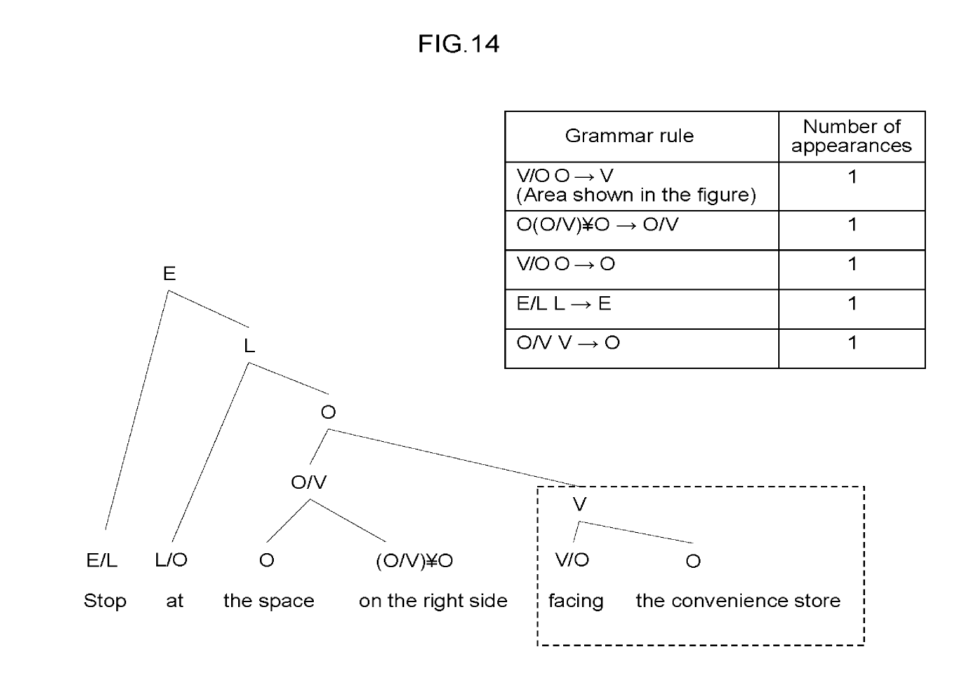

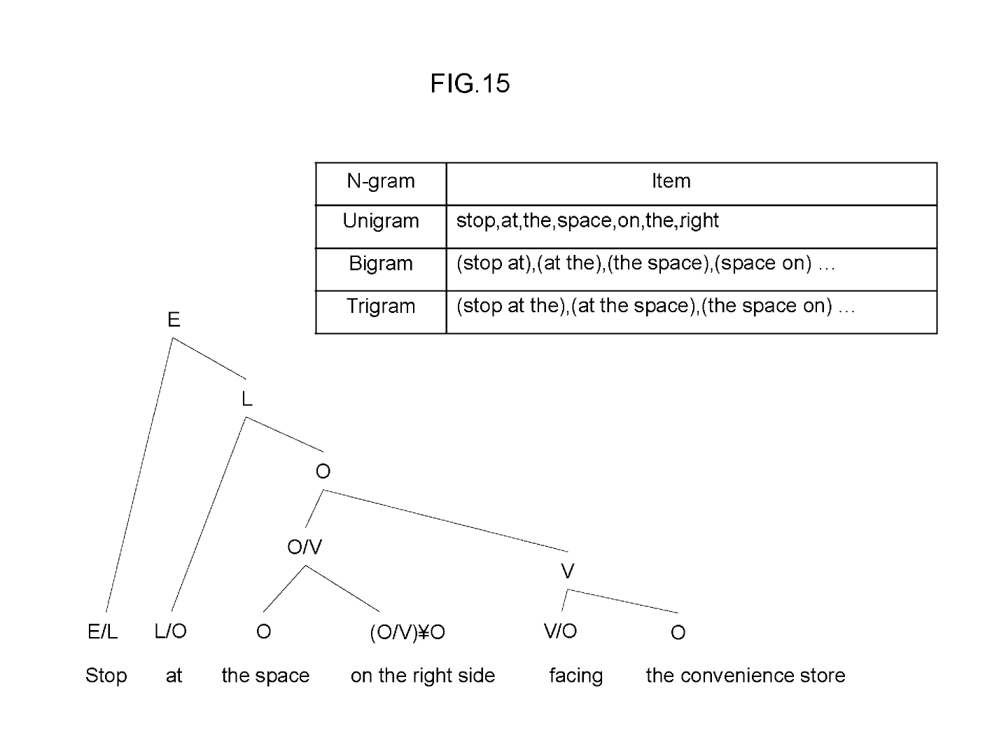

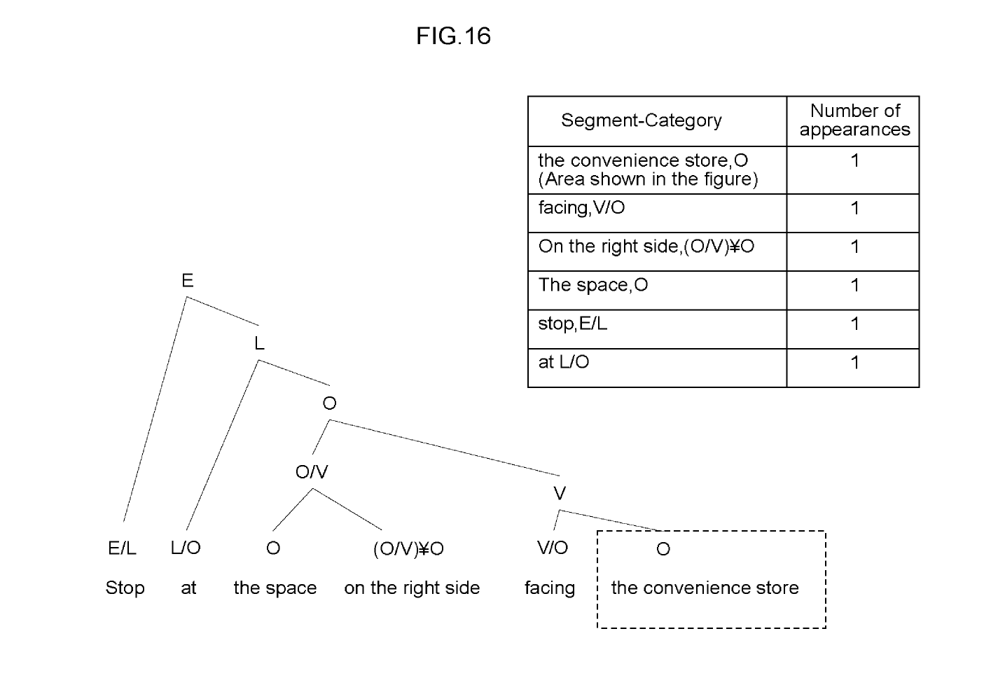

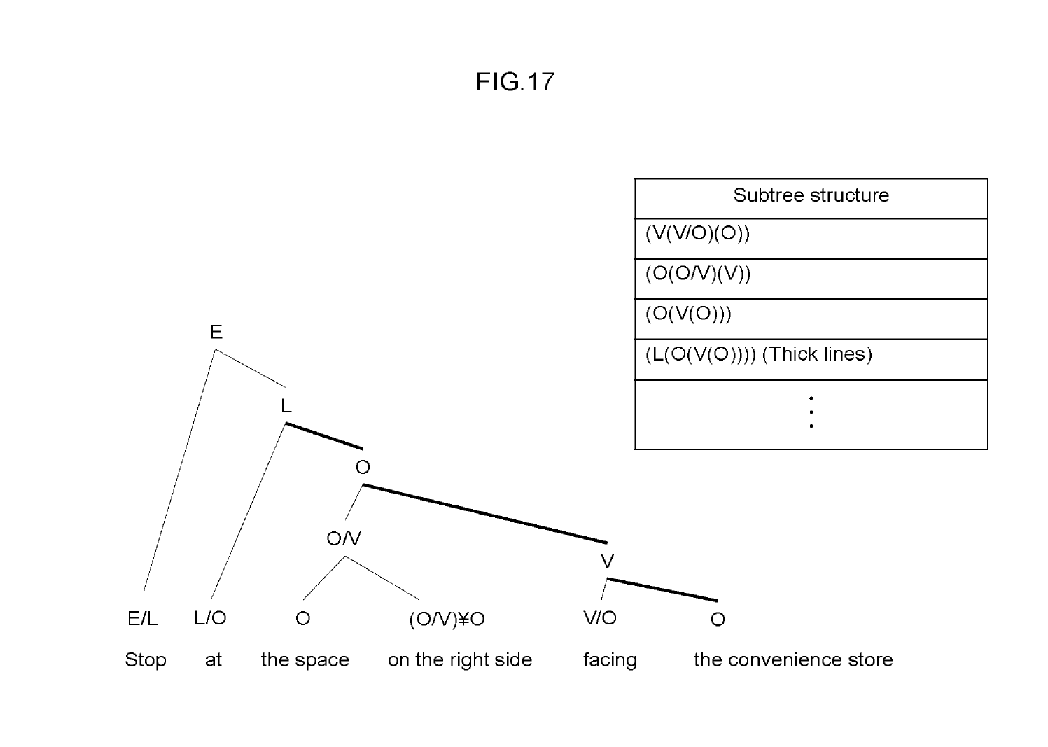

FIG. 14 shows grammar rule patterns in an illustrative syntax tree. In FIG. 14 the area enclosed by the dotted line is a grammar rule example. The number of appearances of each grammar rule is determined for syntax trees (correct/incorrect solutions). FIG. 15 shows the number of N-grams in the illustrative syntax tree. Unigram, bigram, and trigram items are determined as shown in FIG. 15. The number of appearances of N-grams corresponding to each item is determined for syntax trees (correct/incorrect solutions). FIG. 16 shows the number of segment-category pairs in the illustrative syntax tree. The number of appearances of each pair is determined for syntax trees (correct/incorrect solutions). In FIG. 16 the area enclosed by the dotted line is a segment-category pair example. FIG. 17 shows the structures of subtrees with a depth of 2 to 5 in the illustrative syntax tree. In FIG. 17 the part illustrated with bold lines is a subtree structure example. The number of appearances of each subtree structure is determined for syntax trees (correct/incorrect solutions).

With features like those shown in FIGS. 14 to 17 being determined in advance for syntax trees whose correct and incorrect solutions are known, features of positive-class and negative-class syntax trees are learned by using as training data the syntax trees whose features and correct/incorrect solutions are known. In reranking, the above-described four features for a target syntax tree are applied to the features determined by learning in advance, and which of the positive-class and negative-class syntax trees has a higher probability is determined.

The tree structure generator 23 then generates a tree structure in which the categories are hierarchically put together by combining categories of neighboring constituents in accordance with a predetermined function application rule.

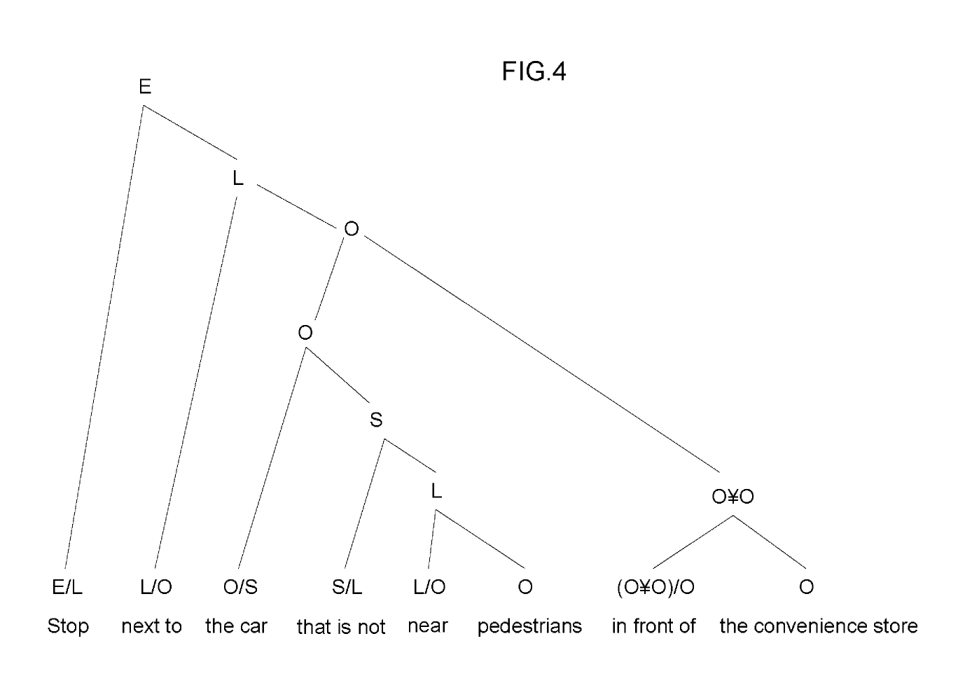

FIG. 4 shows an example in which constituents of a control sentence “Stop next to the car that is not near pedestrians in front of the convenience store” are put together into a tree structure. For example, take a look at two neighboring constituents “in front of” ((O¥O)/O) and “the convenience store” (O). The category of “in front of” indicates that O (object) modifies the constituent “in front of” from the back, and therefore the category becomes (O¥O) through modification by “the convenience store” (O). Taking a look at “near” (L/O) and “pedestrians” (O), O (object) modifies the constituent “near” from the back, and therefore the category becomes (L) through modification by “pedestrians” (O). In this manner, categories of neighboring constituents are combined in accordance with a predetermined function application rule and thus a tree structure like that shown in FIG. 4 is generated.

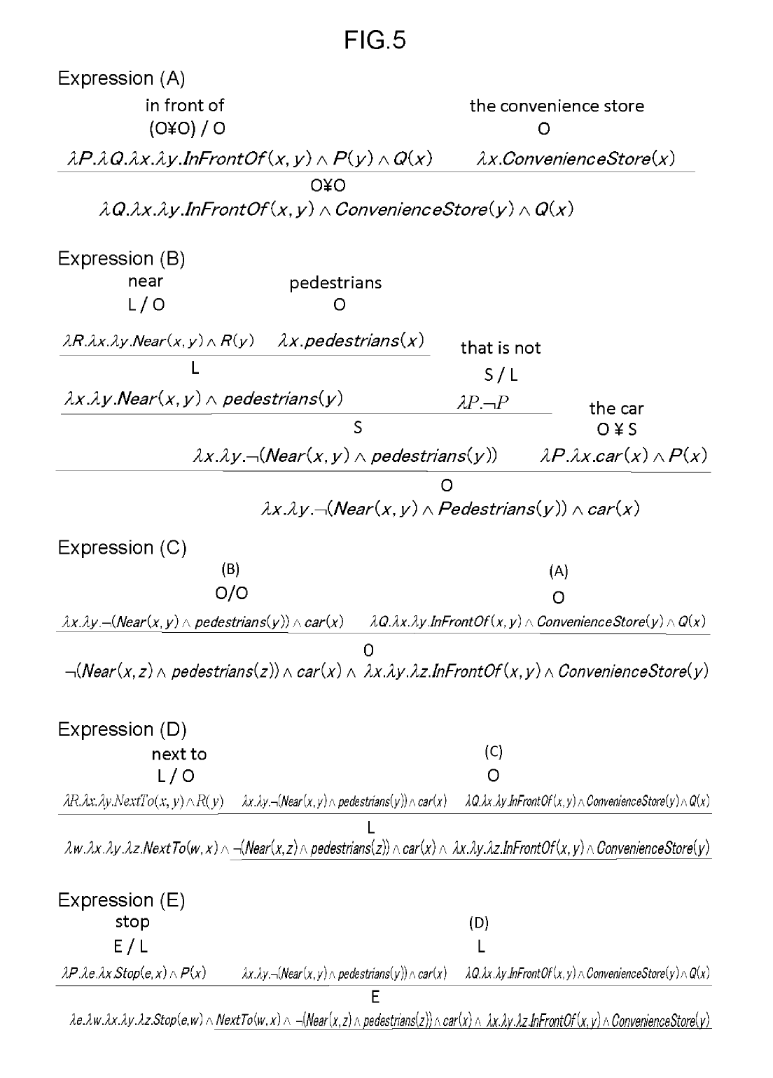

FIG. 5 shows logical expressions for each node in the tree structure. A notation called lambda expression is used in FIG. 5. The expression (A) in FIG. 5 is a lambda expression representing “in front of” and “the convenience store” on the right side of the tree structure shown in FIG. 4, and the expression (B) is a lambda expression representing “the car,” “that is not,” “near,” and “pedestrians.” The expression (C) is the application of the expressions (A) and (B). The expression (D) is the application of the lambda expression for “the car that is not near pedestrians in front of the convenience store” calculated by the expression (C) and a lambda expression representing “next to.” The expression (E) is the application of the lambda expression for “next to the car that is not near pedestrians in front of the convenience store” calculated by the expression (D) and a lambda expression representing “stop,” and the expression (E) allows the sentence to be represented by a lambda expression. Note that the applications of lambda expressions are described from top to bottom in FIG. 5 contrary to the tree structure in FIG. 4 for convenience sake.

If there is a constituent to which the predetermined function application rule is not applicable in this tree structure generation process, some wording may be omitted from the constituents. In this case, the tree structure generator 23 infers and makes up for the omitted constituent to generate the tree structure. As a way to infer an omitted constituent, background knowledge about the representation of events may be used, for example. For example, suppose that a control sentence “Stop on the most right” is inputted. Background knowledge suggests that a car can be stopped in a vacant space, and therefore the wording omitted from the control sentence in the above example can be made up for as “Stop at the vacant space on the most right.”

Knowledge about public preferences may be used in addition to background knowledge. For example, suppose that a control sentence “Stop on the left” is inputted. Background knowledge suggests that a car can be stopped in a vacant space as with the above example. If knowledge about people's preferences suggests that the middle of vacant space would be better if possible, the wording omitted from the control sentence in the above example can be made up for as “Stop in the middle of vacant space on the left.” In this way, the use of background knowledge and knowledge about preferences allows for revising a control sentence provided by a user to an appropriate expression to generate the tree structure of the control sentence.

A specific configuration for using background knowledge and knowledge about people's preferences involves introducing a lambda expression representing background knowledge or the like into the lambda expression of a control sentence, and checking the truth of the whole lambda expression. A parsing result that provides a semantic interpretation of the control sentence that makes the check result be true is adopted from among potential parsing results of the control sentence.

While the example in which background knowledge is used has been given as an example of making up for omitted wording, methods to make up for omitted wording are not limited to the method in which background knowledge is used. For example, omitted words may be inferred and made up for by means of N-grams or pattern matching.

When there is an unknown constituent, the category of the unknown word is estimated. Conditional random fields (CRF) or other sequence labeling tasks are used for the estimation. If the generation of a syntax tree fails with an estimated category, all possible categories are applied thereto and those that allow for the syntax tree generation are adopted as candidates.

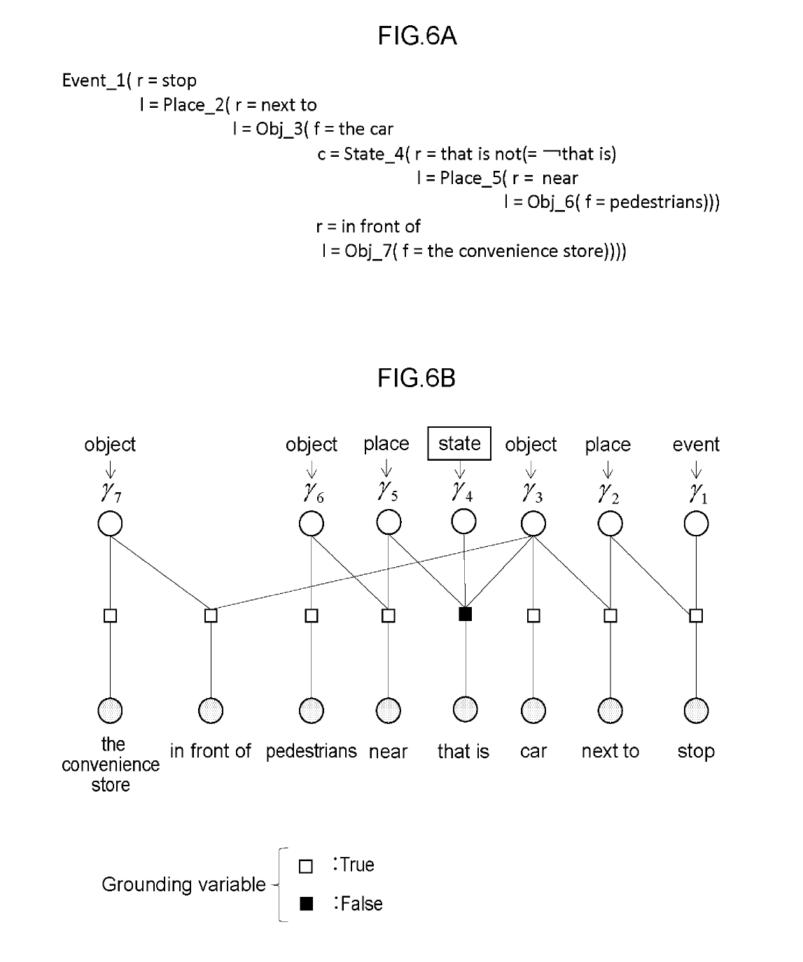

The hierarchical structure generator 24 has a function to generate a hierarchical data structure based on a tree structure generated by the tree structure generator 23. The hierarchical structure generator 24 transits from the root of the tree structure to its lower-level nodes through nodes having atomic categories and, in accordance with the categories of the passed-through nodes, generates each node of a hierarchical data structure representing spatial meaning. The hierarchical structure generator 24 parses all the nodes in the tree structure and thereby generates a hierarchical data structure representing spatial meaning (Spatial Description Clause) like that shown in FIG. 6A.

The grounding graph generator 25 has a function to generate a grounding graph for establishing correspondences between constituents of a control sentence inputted from a user and spatial position relations between real objects. FIG. 6B shows an example of a grounding graph. A grounding graph consists of a plurality of submodels. Each submodel has a first variable group related to the constituents of an inputted sentence, a second variable group related to spatial position relations between objects, and a third variable group related to correspondence relations in grounding, which allows for determining a certainty factor for the match between the constituents and the spatial position relations. A grounding graph provides a certainty factor of a whole hierarchical structure as a function of certainty factors of the submodels. In the grounding graph shown in FIG. 6B, the third variable below “state” is filled with black. This is because a constituent “that is not” is represented by the state of a constituent “that is” being false.

The matching unit 26 applies data on external real objects to a grounding graph, and establishes correspondences between a control sentence and the real objects based on the certainty factor of the grounding graph.

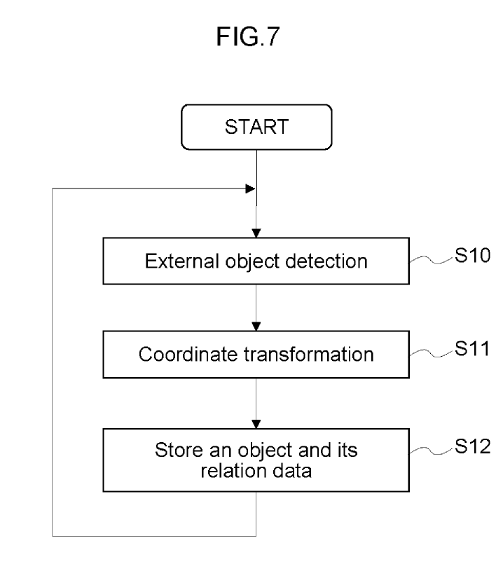

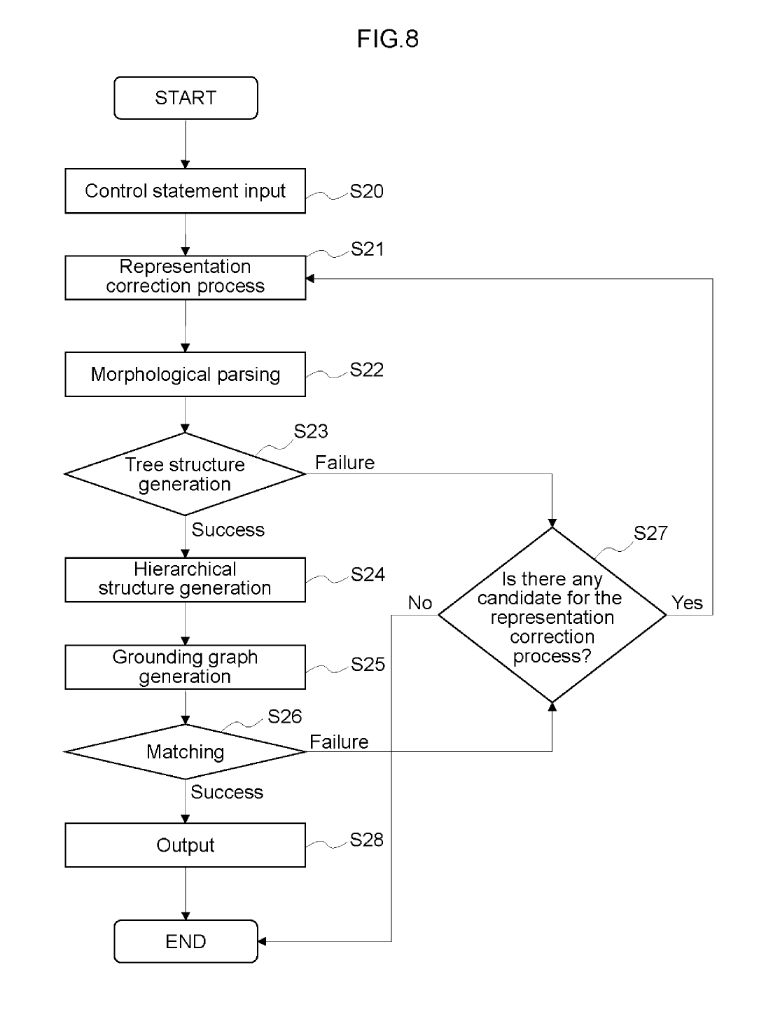

FIGS. 7 and 8 are flowcharts showing operations of the information processing apparatus 1 of the embodiment. FIG. 7 shows an operation of the information processing apparatus 1 acquiring external objects and their relation data, and FIG. 8 shows an operation of analyzing information contained in a control sentence when the sentence is inputted from a driver. The operations shown in FIGS. 7 and 8 are performed concurrently. Specifically, the acquisition of data on external objects shown in FIG. 7 is performed all the time and, when a control sentence is inputted from a driver, the operation shown in FIG. 8 is performed in parallel with the acquisition of data on external objects shown in FIG. 7.

The acquisition of data on external objects will be described first. As shown in FIG. 7, the information processing apparatus 1 processes an image taken by the camera 30 and detects an external object (S10). Based on data on the current location determined by the positioning device 31, the information processing apparatus 1 also detects, from the map DB 13, POIs around the current location as external objects.

The information processing apparatus 1 transforms the coordinates of the position of the detected external object to a local coordinate system defined with respect to the driver's own vehicle (S11). The local coordinate system has the vehicle as its origin, the vehicle's traveling direction as its longitudinal axis, the direction perpendicular to the traveling direction as its lateral axis, and the size of the vehicle or half the size as its unit, for example. The information processing apparatus 1 also acquires data on relations between detected objects. The information processing apparatus 1 then stores the objects transformed to the local coordinate system and their relation data in the environment DB 14.

The operation for when a control sentence is inputted from a driver will be described with reference to FIG. 8. When a control instruction is given by voice from a driver, the information processing apparatus 1 receives the input of the control statement through the input unit 11 (S20). The information processing apparatus 1 performs pattern matching on the inputted control sentence and performs a paraphrase or other representation correction process (S21). The information processing apparatus 1 subsequently divides the control sentence, whose representation is corrected, into morphemes (S22).

The tree structure generator 23 of the information processing apparatus 1 then performs Shift Reduce Parsing on the morphemes obtained by morphological parsing and determines the constituents and their categories. After that, the tree structure generator 23 generates a tree structure in which the categories are hierarchically put together by combining categories of neighboring constituents in accordance with a predetermined function application rule (S23). If a tree structure cannot be generated in accordance with the predetermined function application rule (Failure at S23), whether there is a candidate for the representation correction process for the control sentence or not is determined (S27). If there is a candidate for the representation correction process (Yes at S27), the information processing apparatus 1 returns to the representation correction process (S21). If there is no candidate for the representation correction process (No at S27), the parsing of the control sentence ends. In this case, the user is encouraged to re-enter the control sentence, for example.

If the tree structure generator 23 succeeded in generating a tree structure of the control sentence (Success at S23), the hierarchical structure generator 24 of the information processing apparatus 1 generates a hierarchical data structure based on the tree structure (S24). The grounding graph generator 25 of the information processing apparatus 1 subsequently generates a grounding graph for establishing correspondences between constituents of the control sentence inputted from the user and spatial position relations between real objects (S25).

The information processing apparatus 1 then applies data on external real objects to the grounding graph, and establishes correspondences between the control sentence and the real objects based on the certainty factor of the grounding graph (S26). If the establishment of correspondences results in failure (Failure at S26), whether there is a candidate for the representation correction process for the control sentence or not is determined (S27). If there is a candidate for the representation correction process (Yes at S27), the information processing apparatus 1 returns to the representation correction process (S21). If there is no candidate for the representation correction process (No at S27), the parsing of the control sentence ends. In this case, too, the user is encouraged to re-enter the control sentence, for example.

If the information processing apparatus 1 succeeded in establishing correspondences between the control sentence inputted by the user and the real objects (Success at S26), the information processing apparatus 1 interprets information contained in the control sentence in accordance with the correspondences and outputs the control information (S28) to the self-driving controller, for example. This is a description of a configuration and operations of the information processing apparatus of the embodiment of the invention.

The information processing apparatus 1 of the embodiment generates a logical expression in which the categories of the constituents of a control sentence are hierarchically put together and, based on the logical expression and logical expressions representing background knowledge, determines whether the inputted control sentence is correct in expression or not, and therefore can rephrase an inputted control sentence to an appropriate expression even when there are some omissions or unknown words in the control sentence.

The information processing apparatus 1 of the embodiment applies data on objects present in an external environment to a grounding graph for establishing correspondences between constituents of a control sentence inputted from a user and spatial position relations between real objects, determines the certainty factor of the graph, and can thus establish correspondences between the control sentence and the real objects.

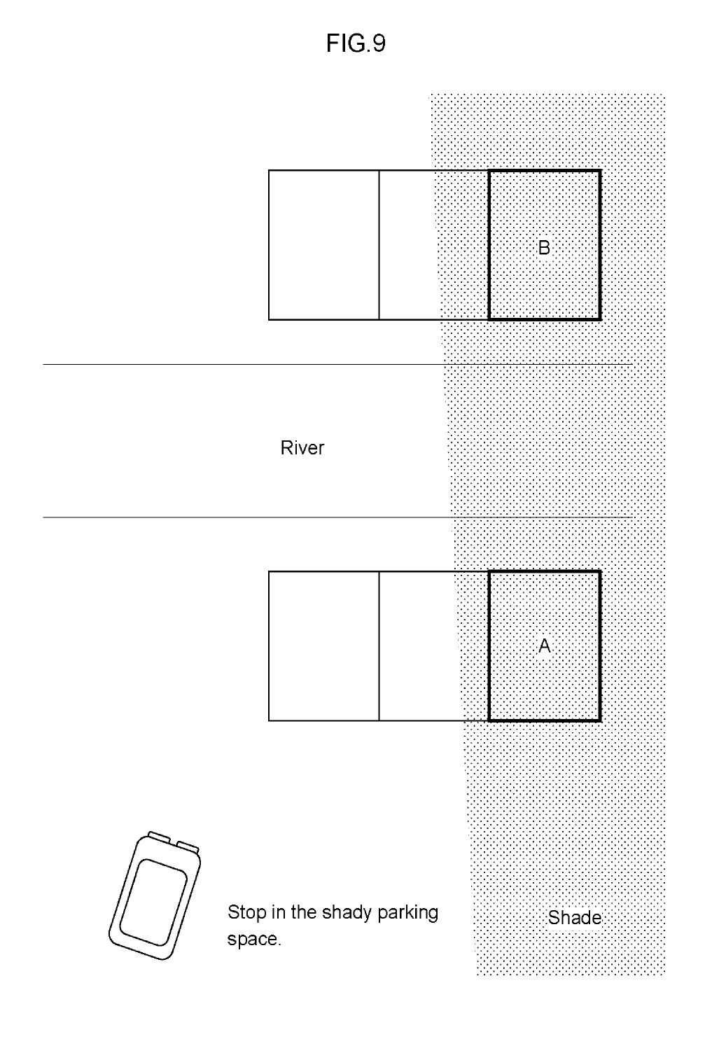

FIG. 9 shows an example of grounding a real object using the information processing apparatus 1 of the embodiment. There are three parking spaces each on both near and further sides of a river in the example shown in FIG. 9. Their respective rightmost parking spaces A and B are shady. Now, suppose that a user gives a control instruction “Stop in the shady parking space.” Then, the shady parking spaces A and B are candidates. With the application of object relation data suggesting that the vehicle cannot go from the current location to the parking space B because it is across the river, a correspondence between “the shady parking space” and the parking space A is established.

The information processing apparatus 1 of the embodiment has a category of S (state) as the category of a constituent, and therefore can appropriately distinguish and recognize the same objects or spaces whose states are different from one another. The information processing apparatus 1 of the embodiment has a category of P (path) as the category of a constituent, and therefore can handle even an expression for a path connecting multiple points. The information processing apparatus 1 of the embodiment has a category of V (viewpoint) as the category of a constituent, and therefore can handle even an expression with a change in viewpoint.

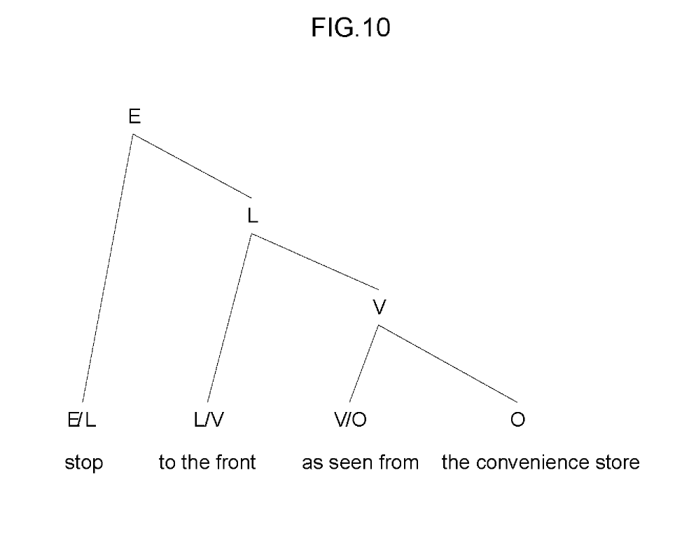

FIG. 10 shows an example of a control sentence with a change in V (viewpoint), “Stop to the front as seen from the convenience store.” Parsing by the information processing apparatus 1 divides this control sentence into constituents “stop,” “to the front,” “as seen from,” and “the convenience store.” One of these constituents, “as seen from,” falls into the category of viewpoint, and O (object) modifies this constituent from the right.

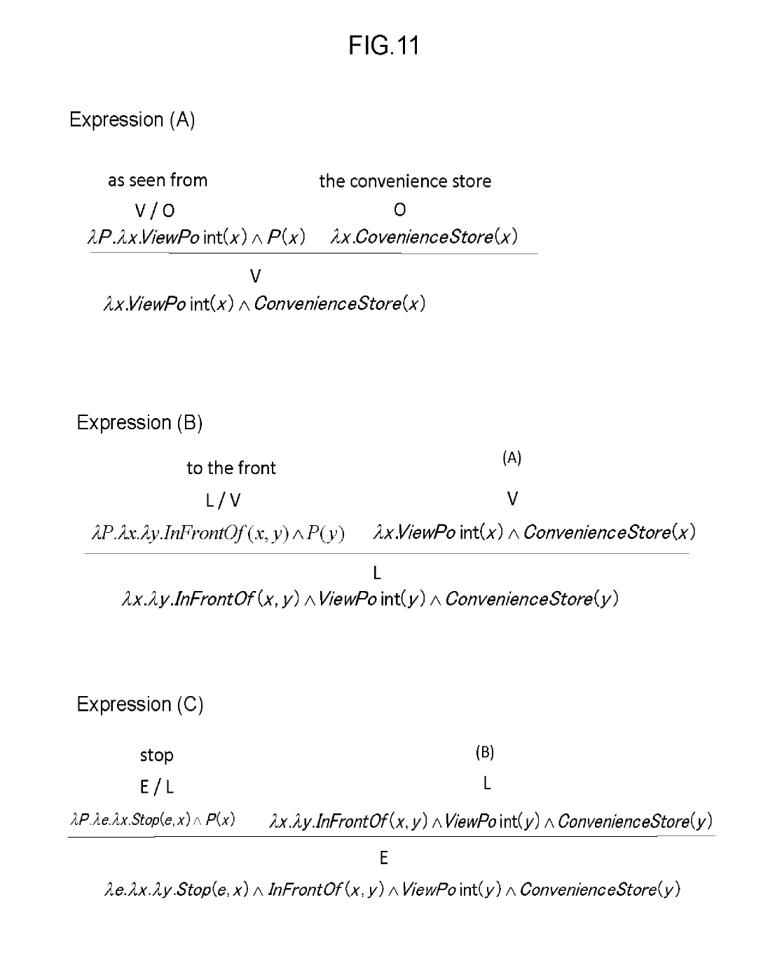

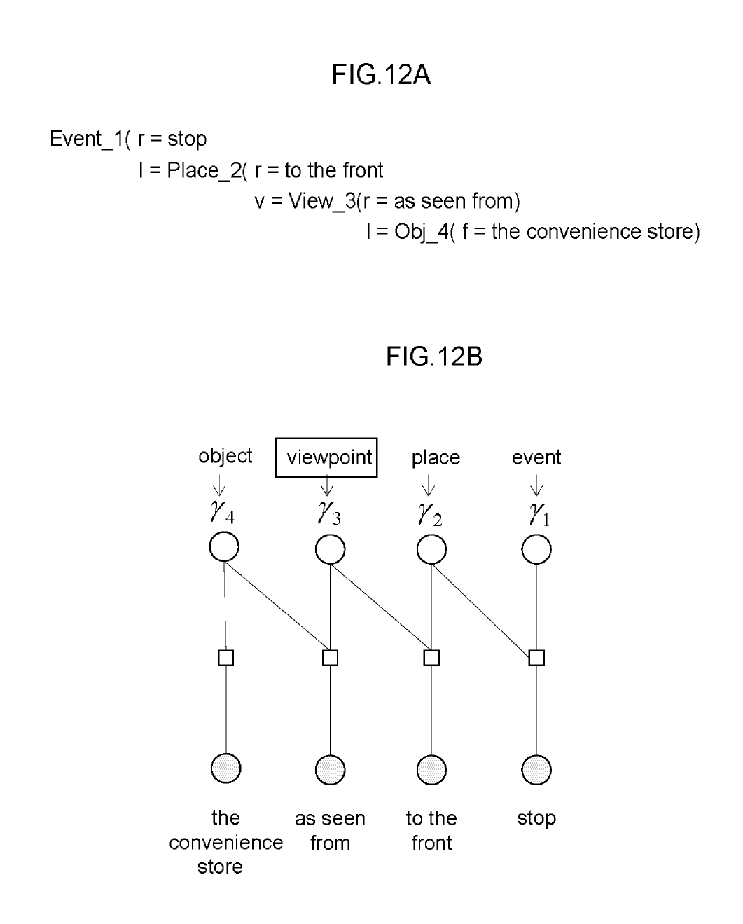

This control sentence has a tree structure shown in FIG. 10, and its lambda expressions can be written as shown in FIG. 11. They can be converted to a hierarchical data structure representing spatial meaning shown in FIG. 12A, which provides a grounding graph shown in FIG. 12B.

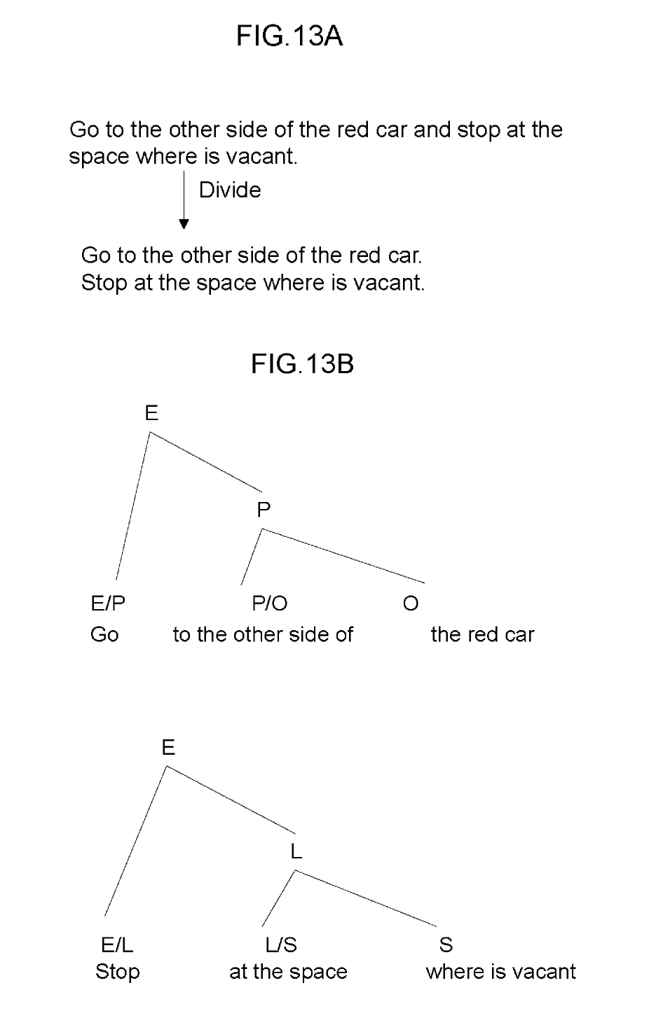

While there has been described examples in which the representation corrector 21 performs rephrasing or makes up for an elliptical expression in the embodiment described above, the representation corrector 21 may also have a function to divide a control sentence into a plurality of simple sentences if the control sentence is a complex sentence. FIG. 13A shows an example of the division of a complex sentence into simple sentences. In the example shown in FIG. 13A, a control sentence “Go to the other side of the red car and stop at the space where is vacant,” which is a complex sentence, is divided into two simple sentences “Go to the other side of the red car” and “Stop at the space where is vacant.” The tree structure generator 23 then generates a tree structure for each divided simple sentence as shown in FIG. 13B.

1. An information processing apparatus for processing a sentence inputted from an input unit, the apparatus comprising:
a dictionary database storing categories of constituents each consisting of a morpheme or a bundle of morphemes and storing information representing a semantic interpretation of each constituent, the dictionary database containing as the categories the category of object and the category of spatial location;
a morphological parser for performing morphological parsing of an inputted sentence;
a tree structure generator for, with reference to information stored in the dictionary database, providing categories and semantic interpretations of constituents each consisting of a morpheme or a bundle of neighboring morphemes obtained by the morphological parser, generating a tree structure in which the categories are hierarchically put together by combining neighboring categories in accordance with a predetermined function application rule, and generating the meaning of the sentence; and
a hierarchical structure generator for generating a hierarchical structure in which atomic categories of the tree structure are set as nodes.

2. The information processing apparatus according to claim 1, comprising:
a detector for acquiring data on a spatial position relation between objects present in an external space;
a grounding graph generator for generating a grounding graph that has a plurality of submodels connected together according to the hierarchical structure and provides a certainty factor as a function of certainty factors of the submodels, each submodel having
a first variable group related to the constituents of the sentence,
a second variable group related to spatial position relations between objects, and
a third variable group related to correspondence relations in grounding; and
a matching unit for applying data on spatial position relations between objects detected by the detector to the second variable group of the grounding graph and identifying the objects indicated in the sentence.

3. The information processing apparatus according to claim 1, wherein the tree structure generator determines whether the inputted sentence is consistent with background knowledge or not based on the meaning of the sentence and the meaning supported by background knowledge.

4. The information processing apparatus according to claim 1, wherein the dictionary database contains as the category a category related to the location of a viewpoint.

5. The information processing apparatus according to claim 1, wherein the dictionary database contains as the category a category related to the state of an object or a space.

6. The information processing apparatus according to claim 1, wherein the dictionary database contains as the category a category related to a path.

7. The information processing apparatus according to claim 1, comprising a representation correction processor for rephrasing a sentence inputted from the input unit as required.

8. The information processing apparatus according to claim 1, comprising a representation processor for converting a sentence inputted from the input unit to a plurality of simple sentences if the sentence is a complex sentence.

9. The information processing apparatus according to claim 1, wherein the tree structure generator generates the tree structure by inferring wording omitted from the sentence based on a knowledge database storing background knowledge.

10. The information processing apparatus according to claim 1, wherein the tree structure generator determines that some wording is omitted from the sentence and infers the omitted wording if neighboring categories do not conform with a predetermined function application rule.

11. The information processing apparatus according to claim 2, determining that some wording is omitted from the sentence and inferring the omitted wording if an object corresponding to the second variable group of the grounding graph is not identified by the matching unit.

12. The information processing apparatus according to claim 1, wherein the tree structure generator generates a tree structure by inferring the nature of an unknown word contained in an inputted sentence based on data on constituents stored in the dictionary database or based on the context of the inputted sentence.

13. The information processing apparatus according to claim 1, wherein the tree structure generator
determines a plurality of potential syntax trees consisting of constituents each consisting of a morpheme or a bundle of neighboring morphemes,
reranks the plurality of potential syntax trees with a (feature-based) predictive analysis using, as the features of a syntax tree,
(i) the number of appearances of grammar rule patterns,
(ii) the number of N-grams of segments,
(iii) the number of segment-category pairs, and
(iv) the number of subtrees, and
generates a tree structure with a maximum probability of being correct.

14. An information processing method for parsing a sentence inputted from a user by means of an information processing apparatus, the method comprising the steps of:
the information processing apparatus receiving an input of a sentence from a user;
the information processing apparatus performing morphological parsing of an inputted sentence;
the information processing apparatus, with reference to information stored in a dictionary database storing categories of constituents each consisting of a morpheme or a bundle of morphemes and storing information representing a semantic interpretation of each constituent, the dictionary database containing as the categories the category of object and the category of spatial location, providing categories and semantic interpretations of constituents each consisting of a morpheme or a bundle of neighboring morphemes obtained by the morphological parsing, generating a tree structure in which the categories are hierarchically put together by combining neighboring categories in accordance with a predetermined function application rule, and generating the meaning of the sentence; and
the information processing apparatus generating a hierarchical structure in which atomic categories of the tree structure are set as nodes.

15. A program for parsing a sentence inputted from a user, the program causing a computer to execute the steps of:
receiving an input of a sentence from a user;
performing morphological parsing of an inputted sentence;
with reference to information stored in a dictionary database storing categories of constituents each consisting of a morpheme or a bundle of morphemes and storing information representing a semantic interpretation of each constituent, the dictionary database containing as the categories the category of object and the category of spatial location, providing categories and semantic interpretations of constituents each consisting of a morpheme or a bundle of neighboring morphemes obtained by the morphological parsing, generating a tree structure in which the categories are hierarchically put together by combining neighboring categories in accordance with a predetermined function application rule, and generating the meaning of the sentence; and
generating a hierarchical structure in which atomic categories of the tree structure are set as nodes.
